(19) United States
(12) Patent Application Publication
(10) Pub. No.: US 2017/0352051 A1
(43) Pub. Date: Dec. 7, 2017

(54) METHODS, SYSTEMS, AND COMPUTER READABLE MEDIA FOR PROVIDING A PERSONALIZED OFFERS INTEGRATION PLATFORM

(71) Applicant: MasterCard International Incorporated, Purchase, NY (US)

(72) Inventors: Tim M. Watkins, Foster City, CA (US); Aravind Mattaparthi, Sunnyvale, CA (US); Ravikumar Kuppusamy, Belmont, CA (US); Mahes Kumar Subramanian, Fremont, CA (US); Marimuthu Vellingiri, Belmont, CA (US)

(21) Appl. No.: 15/172,123

(22) Filed: Jun. 2, 2016

(51) Int. Cl. G06Q 30/02; G06Q 20/36; G06Q 20/20

(52) U.S. Cl. CPC G06Q 30/0229; G06Q 30/0238; G06Q 20/20; G06Q 20/363; G06Q 30/0224

(57) ABSTRACT

Methods, systems, and computer readable media for providing a personalized offers integration platform are provided. Personalized offers may be based on transaction details, geographic locations, and/or consumer preferences. In one embodiment, a wallet system, user equipment, electronic devices, and a payment and offers integration platform (POIP) are provided. The wallet system can receive of transaction details, geographic locations, and/or consumer preferences associated with a point of sale transaction. The received information may be translated into metadata, and an offer request is generated that includes the metadata. The POIP is configured to receive the offer request, determine a set of criteria from the metadata, query a plurality of offer or reward engines using the set of criteria for retrieving offers that correlate to the offer request, receive a plurality of offers from the plurality of offer or reward engines, and integrate the plurality of offers for formulating an offer response.

### TECHNICAL FIELD

The subject matter described herein generally relates to methods and systems for a computing platform that integrates and presents a plurality of personalized offers to consumers. More particularly, the subject matter described herein relates to systems, methods, and computer readable media for providing a personalized offers integration platform.

### BACKGROUND

Payment card processing service providers and the merchants utilizing payment card processing services, are constantly seeking ways to increase their respective consumer base and patronage. Payment card processing service providers and merchants alike are struggling to provide relevant, engaging offers (e.g., promotions, advertisements, rewards, loyalty programs, or the like) to consumers.

Currently, payment card processing service providers, such as MasterCard®, American Express®, Visa®, Discover®, or the like, may generate consumer offers using details regarding an amount of money a consumer spent at a given merchant. This is problematic, as the amount of money a consumer spent at a given merchant does not necessarily correlate to the specific good or service purchased. Thus, these types of offers often lack relevance.

Likewise, specific merchants may generate consumer offers using details regarding the items a consumer purchases at the respective merchant; however, these offers are limited to the specific merchant and are not redeemable at different merchants. Thus, these offers may also lack relevance to consumers.

Existing merchant or third party loyalty programs or systems may use consumer offers with details surrounding geographic locations of the merchant, the consumer, or combinations of both; however, these offers are again limited to specific merchant(s). Thus, existing location-based offers may either not be presented at all or may lack relevance to the consumers.

Conventional methods associated with generating and presenting electronic offers are problematic as consumers lack the ability to “opt-in” or “set” specific preferences regarding the offers they receive. Thus, a consumer may receive an abundance of offers that lack relevance for not satisfying the consumer's interest and/or meeting the consumer's preferences.

Accordingly, a need exists for improved methods, systems, and computer readable media associated with providing a personalized offers integration platform.

### SUMMARY

According to one aspect, the subject matter described herein relates to methods, systems, and computer readable media for electronically integrating and correlating offers based on transaction details, geographic location details, and/or consumer preference details.

In an exemplary embodiment, a method of electronically integrating and correlating offers includes receiving, at a wallet system via a packet-based network, transaction details, geographic location details, or consumer preference details associated with a point of sale (POS) transaction, translating, at the wallet system, the plurality of transaction details, geographic location details, or consumer preference details into metadata associated with the POS transaction and generating an offer request including the metadata.

The method may also include receiving, at a payment and offers integration platform (POIP) via a packet-based network, the offer request that includes the metadata, determining, at the POIP, a set of criteria from the metadata, and querying a plurality of offer and/or reward engines, which are configured to generate rewards and/or offers for a plurality of different merchants or agents, using the set of criteria for retrieving offers that correlate to the offer request. The method may further include receiving, at the POIP via the packet-based network, a plurality of offers from the plurality of offer or reward engines, integrating, at the POIP, the plurality of offers for formulating an offer response, and responding, via the packet-based network, to the offer request with the offer response.

An exemplary system for integrating and correlating offers based on transaction details, geographic locations, and/or consumer preferences is provided. The POIP system may communicate with and/or include any number of external systems serving as a wallet or wallet system (e.g., MasterPass®, ApplePay®, SamsungPay®, Paypal®, etc.) as well as any offers and/or rewards interfaces which may take the form of numerous device and/or system types which may be configured to receive a plurality of transaction details, geographic location details, and/or consumer preference details associated with a POS transaction via a packet-based network.

The wallet system may be configured to translate the plurality of transaction details, the geographic location details, or the consumer preference details into metadata associated the POS transaction, and generate an offer request including the metadata. The system may further include a POIP configured to receive the offer request that includes the metadata via a packet-based network, determine a set of criteria from the metadata and query a plurality of offer or reward engines, which are configured to generate rewards for a plurality of different merchants or agents, using the set of criteria for retrieving offers that correlate to the offer request, the POIP is also configured to receive a plurality of offers from the plurality of offer or reward engines, integrate the plurality of offers for formulating an offer response, and respond to the offer request with the offer response via the packet-based network.

In another embodiment, an electronic device or system (EDS) or other user equipment (UE), which contains computer readable medium having stored thereon executable instructions that when executed by the processor of a computer control the computer to perform steps and/or a method. The method includes receiving, within a system, geographic location details, and/or consumer provided details that are associated with the consumer's location or preferences. The method further includes translating, within the system, the geographic location details, and/or the consumer preference details into metadata associated with the consumer preferences and/or location-based details and generating an offer request including the metadata. The method further includes receiving, at a payment and offers integration platform (POIP) via a packet-based network, the offer request that includes the metadata. The method further includes determining, at the POIP, a set of criteria from the metadata and querying a plurality of offer or reward engines, which are configured to generate rewards for a plurality of different merchants or agents, using the set of criteria for retrieving offers that correlate to the offer request. The method further includes receiving, at the POIP via the packet-based network, a plurality of offers from the plurality of offer or reward engines. The POIP is configured to integrate the plurality of offers for formulating an offer response and respond, via the packet-based network, to the offer request with the offer response.

The subject matter described herein may be implemented in hardware, software, firmware, or any combination thereof. As such, the terms “function”, “engine”, and/or “platform” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps.

Exemplary computer readable media suitable for implementing the subject matter described herein may include non-transitory computer-readable media, such as disk memory devices, chip memory devices, programmable logic devices, and application specific integrated circuits. In addition, a computer readable medium that implements the subject matter described herein may be located on a single device or computing platform or distributed across multiple devices or computing platforms.

The subject matter described herein includes communicating messages across a packet-based communications network, where the messages may include payloads with transaction details and/or metadata corresponding to transaction details, including, but not limited to details regarding the date of the transaction, the time of the transaction, the physical location of the transaction, the merchant, the amount of the transaction, and an indication of one or more specific items purchased during the transaction.

The subject matter described herein also includes communicating messages across a packet-based communications network, where the messages include payloads with geographic location details and/or metadata corresponding to geographic location details, including, but not limited to details regarding the physical address of the location, the latitude and/or longitude of the location, the GPS coordinates of the location, network specific location encoding, and other GEO location details indicative of the location of the consumer's handset device, additional electronic devices or which has the capability of transmitting GEO Location details of itself and/or the merchant location(s).

The subject matter described herein includes, at a special purpose computing platform, integrating and correlating various offers or rewards from various existing offer or rewards platforms using the transaction-specific, geographic location-specific, or consumer preference-specific data that is translated into metadata. In some embodiments, integrating and correlating various offers or rewards from various offer or reward platforms includes invoking an application programming interface (API) configured to assist otherwise distinct applications with sharing data across a packet-based network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating exemplary network and/or computing architecture for integrating and correlating offers based on transaction details, geographic location details, customer preferences and/or any combination thereof according to an embodiment of the subject matter described herein;

FIG. 2 is a schematic block diagram illustrating exemplary messaging and a high-level process flow associated with integrating and correlating offers based on transaction details, geographic location details, customer preferences and/or any combination thereof according to an embodiment of the subject matter described herein;

FIGS. 3A and 3B are schematic block diagrams illustrating exemplary messaging and a more granular process flow associated with integrating and correlating offers based on transaction details, geographic location details, customer preferences and/or any combination thereof according to an embodiment of the subject matter described herein; and

FIG. 4 is a schematic block diagram illustrating an exemplary process for integrating and correlating offers based on transaction details, geographic location details, customer preferences and/or any combination thereof according to an embodiment of the subject matter described herein.

### DETAILED DESCRIPTION

In accordance with the subject matter disclosed herein, methods, systems, and computer readable media for electronically integrating and correlating offers based on any combination of transaction details, location details, and/or consumer preferences are provided. In some embodiments, the transaction details are associated with a specific good or service that is purchased by a consumer, or any information indicative of a consumer's purchasing behavior. In some embodiments, the location details are indicative of a GEO location where the purchase was made or a location provided by an external system or device (e.g., a location of an electronic device, a wallet system, or the like). In some embodiments, consumer preference details are configured by a user (consumer) and include details regarding what offers are received, how the offers are received (e.g., text, email, etc.), when the offers are received, where the offers are received, and which merchant offers to retrieve.

Utilizing transaction details, location details, and/or customer preferences to integrate and match offers provided from various different offer or rewards engines advantageously provides individual consumers with targeted offers that are more specific, tailored, and/or otherwise more relevant to a respective consumer. In some aspects, transaction details include data or information indicative of an individual (specific) consumer's purchasing behavior, which may be flagged or tagged with metadata (e.g., specific data elements, codes, or the like) and used as input to one or more algorithms for correlating the consumer's behavior to relevant/matching offers thereby providing intelligent creation, distribution, and/or presentation of offers to consumers. Location details and/or consumer preferences may be matched or factored into the algorithm for further improving intelligent offer generation, correlation, integration, and distribution.

Electronically integrating and correlating personalized offers as described herein advantageously allows various parties to a purchase transaction to subscribe to a payment and offers platform for leveraging information regarding an individual consumer, their interests, their location, and their respective purchasing behavior for use in more intelligent offer generation, distribution, and/or presentation. For example, merchants, payment card processing providers (e.g., MasterCard®, etc.), issuers (e.g., banking institutions, financial institutions, or the like), or any other party to a purchase transaction may enroll and/or subscribe to a payment and offers integration platform (POIP) to create and/or inject offers for integration. Likewise, consumers may subscribe or “opt-in” to receive communications from the POIP or another device/system, which may interact with the POIP, so that offers received therefrom, conform to preferences and interests set by a respective consumer.

The subject matter herein advantageously leverages line-item goods and service purchasing information and/or purchasing history in conjunction with user preferences and consumer/merchant location information to present and target offers/advertisements to the end user (consumer).

In some embodiments, a payment platform or wallet system (e.g. MasterPass®, ApplePay®, SamsungPay®, PayPal®, etc.) may communicate payload information including transaction details, location details, and/or consumer preferences in an offer request across a packet-based network. The offer request may be received at the POIP when a subscribed consumer is conducting a payment transaction for one or more goods or services at a point of sale (POS). The payload information (e.g., transaction details, location details, and/or consumer preferences) are formulated into a set of criteria used to electronically query, match, and/or otherwise filter various offers from multiple different sources (e.g., various offer and/or rewards engines). The most relevant offers are matched to the set of criteria, integrated, and then sent in real time via the packet-based network to the consumer, the merchant, or any other system/device at the POS in response to receiving the offer request. Thus, the relevance and quality of offers that are created, generated, retrieved, and/or presented to a consumer improves, which further increases consumer engagement and offer redemption.

Electronically correlating offers to transaction details, and electronically integrating the correlated offers as described herein advantageously obviates the need for performing manual processes (e.g., manual searches for offers, rewards, coupons, etc.) prior to purchasing a good or service.

As used herein, the term “transaction details” refers to any detail which may be associated with a purchase for a good or service, including, but not limited to the day of the purchase (e.g., a day of the week), the date of the purchase (e.g., a day of the month and/or year), the time of the purchase (e.g., hour and/or minute), the stock keeping units (SKU) of the item (good) purchased, or the like. SKU information (also referred to as “SKU details” or “SKU-level details”) may include a SKU code, an alphanumeric code, a numeric code, or any unique code that is associated with a given item (good) and/or a given merchant. Any other information that is typically provided on a customary receipt (printed or electronic) for a purchased good or service is considered a “transaction detail” that may be electronically communicated according to methods set forth herein.

As used herein, the term “geographic location details” refers to any detail which may be associated with a merchant location, a consumer location, a POS location, a location of any offer presentation system or device, and/or combinations thereof, including, but not limited to the location of the purchase, a location of the consumer, global positioning system (GPS) location information (e.g., for a merchant, POS, or consumer), a location code (e.g., for a merchant, POS, or consumer), longitude/latitude coordinates of the merchant, POS, or consumer, an ISP or mobile application GPS location of the merchant, POS, or consumer, a street address of the location, a zip code, or any other detail indicative of a location of a merchant, consumer, and/or POS.

As used herein, the terms “consumer preference(s)” and/or “consumer preference details” refer to any detail, which may be associated with a respective consumer that has “subscribed to” and/or “opted in” to receive offers. Consumer preferences may include specific offers (e.g., brands, items, or the like) that the respective consumer wishes retrieved, specific agents or merchants that the respective consumer wishes retrieved, offers within a maximum distance that the respective consumer wishes retrieved, a maximum number of offers to retrieve, the type of offers retrieved (e.g., promo codes, min/max percentages off, buy-on-get-one offers, offers for free shipping, or the like). In some aspects, a wallet system is configured to receive messages having payloads including transaction details, geographic location details associated with merchant or consumer location, or consumer preferences and translate the payloads into metadata.

Reference will now be made in detail to exemplary embodiments of the subject matter described herein, examples of which are illustrated in the accompanying drawings. Wherever possible, the same reference numbers will be used throughout the figures, also “FIGS.”, to refer to the same or like entities.

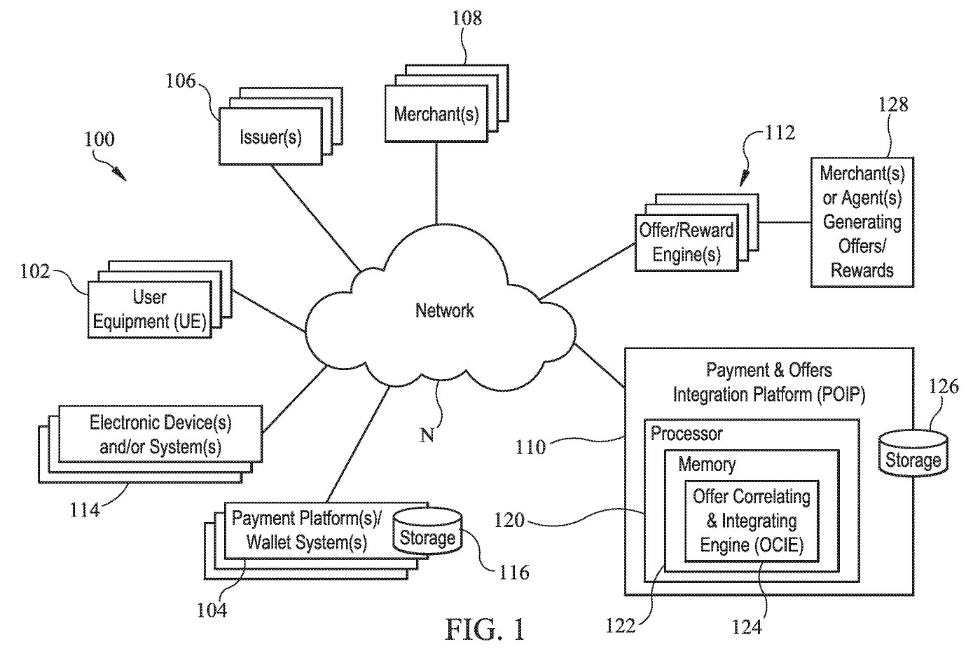

FIG. 1 is a schematic diagram illustrating an exemplary network and/or computing architecture 100 associated with electronically integrating and correlating offers based on transaction details, geographic details, and/or consumer preferences according to an embodiment of the subject matter described herein. In some embodiments, architecture 100 includes multiple different and/or distinct computing and/or network entities for facilitating an in-person or electronic commerce (e-commerce) purchase transaction for a good and/or a service that is purchased using at least one mobile or non-mobile payment-enabled device, referred to as user equipment (UE) 102. In some embodiments, architecture 100 includes multiple different and/or distinct computing and/or network entities for facilitating the display, delivery, and/or redemption of offers and/or rewards pertaining to goods and/or services of interest to the consumer using any number of Electronic Device(s) and/or System(s) (EDS) 114.

UE 102 and EDS 114 are shown as separate entities in FIG. 1, as UE 102 may include, for example, a consumer/user's personal device such as any type of mobile or non-mobile payment enabled device such as a phone, a computer, a smart device, a laptop computer, a tablet computer, a desktop computer, a smart planner or organizer, a smart television, a wearable computer (e.g., a watch or eyeglass mounted computer), or the like.

On the other hand, exemplary EDSs 114 may not necessarily be associated with a specific consumer, for example, and may include any type of EDS such as a payment enabled vending machine, an automated teller machine (ATM), a vehicle dashboard user interface, any number of hand-held electronics, a metro payment terminal, a taxicab payment terminal, a payment terminal associated with a seat of an aircraft, an interactive advertising panel, a smart appliance, a smart poster, an airline services payment terminal, a payment enabled parking meter, a phone, a computer, a touch-screen interface, a smart television, a wearable computer, or the like.

During the purchase transaction and/or at the conclusion of the purchase transaction, multiple offers are correlated according to transaction details associated with the respective purchase, integrated, and presented to the consumer in real time at a point of sale (POS). Consumers may utilize UEs 102 for initiating a purchase transaction for a good or service and/or paying for the good or service using information stored on at least one payment platform(s) and/or wallet system(s) 104 accessible using UE 102.

In some embodiments, a network N includes a packet-based communications network (e.g., the Internet) that is accessed by UE 102 and/or EDS 114 via a communications interface. Although not shown, each individual entity (e.g., 102, 104, 106, 108, 110, 112, 114) associated with architecture 100 may reside in an individual (e.g., public or private) network, which may include a same network or different networks, and are not shown for illustration purposes. Network N facilitates communication of data via packets or packet-based messages, which may be communicated between network entities according to any desired communication protocol as known in the art, (e.g., IP, HTTP, TCP, UDP, SIP, or the like).

Network N may be accessed via one or more access nodes, endpoints, or ingress points such as one or more gateways or switches (not shown). For illustration purposes only, a single network N is illustrated for generically depicting the Internet or cloud. Network N can support one or more cloud based entities or services, however, as known in the art, architecture 100 may also include and/or facilitate communications for multiple different (e.g., individual or privately managed) networks and/or communications across multiple different networks for accessing services hosted or provided by various individual entities, such as one or more wallet system(s) 104, issuing server(s) or issuer(s) 106, merchant(s) 108, a payment and offers integration platform (POIP) 110, and/or multiple offer/reward engines, generally designated 112.

UEs 102 and EDSs 114 include any type of electronic device configured to access communication network N, either directly (e.g., via the Internet) or indirectly (e.g., via a merchant reader (not shown), which is configured to read payment information directly from UE 102 and/or EDS 114), initiate a purchase for a good or service, and pay for the good via a wallet system 104. In some embodiments, the purchase is initiated at a physical POS terminal or a virtual POS for a purchase conducted via the Internet, a mobile application, or the like.

UE 102 and/or EDS 114 may access services provided via other network entitles via network N upon signaling across any type of wired or wireless connection or interface (e.g., a WAN, a LAN, a Wi-Fi connection, a radio access connection, or the like). Upon authorization of a purchase transaction, merchant 108 can generate electronic transaction details, electronic location details, or data in the form of a digital receipt. Merchant 108 can then forward the one or more transaction details and/or location details to wallet system 104. Transaction details include any data or information associated with the purchased good or service, for example, the day of purchase, the date of purchase, the time of purchase, and/or SKU-level details that identify the specific item a consumer purchases. Location details include any data or information associated with the POS location, the merchant location, or the consumer location.

In some embodiments, location details may include data associated with the physical address of the location, the latitude and/or longitude of the location, the GPS coordinates of the location, network specific location encoding, and other GEO location details indicative of the location of a respective consumer's UE 102, the location of EDS 114 and/or the merchant location. In response to receiving the one or more transaction details and location details, wallet system 104 is configured to generate and send an offer request to POIP 110 for requesting offers in which the purchasing consumer may have interest.

In some embodiments, the offer request may also include payload information associated with one or more consumer preferences. Wallet system 104 is configured to encode consumer preferences within the offer request, and send the offer request including the transaction details, the location details and/or consumer preferences to POIP 110.

In some embodiments, POIP 110 may correlate offers residing at and/or hosted by various engines 112 via a set of criteria that use the transaction details, location details, consumer preferences, and/or any data associated therewith as input. Notably, engines 112 are populated by various merchant(s) or agent (s) generating offers/rewards 128. That is, various different merchants or agents 128 including specific stores or retail locations (e.g., Macys®, Target®, etc.) and/or brands, agents, or corporations (e.g., Kleenex®, Johnson & Johnson®, Pampers®, etc.) may create offers accessible to POIP 110. In some aspects, engines 112 are configured to generate rewards for a plurality of different merchants or agents. POIP 110 may retrieve and integrate multiple offers from multiple, different engines 112, and present the offers to the consumer via UE 102 at the POS. Notably, the offers retrieved may be redeemed at a same merchant conducting the POS transaction, or different merchants, some within the same geographic location as the merchant or consumer at the POS.

Still referring to FIG. 1 and in some embodiments, a consumer may interface UE 102 at a physical POS to initiate a payment via wallet system 104. In other embodiments, a consumer accessing UE 102 and/or EDS 114 may access merchant 108 via a website, a mobile application, or the like, and initiate a payment via wallet system 104. In this embodiment, merchant 108 includes a merchant server hosted by a seller of goods and/or services (e.g., a company, a corporation, a business, a manufacturer, a supplier, a store, a person, a seller, a retailer, a partnership, or the like). The merchant server may include a POS server configured to complete a POS purchase transaction.

In some embodiments, wallet system 104 is invoked via interfacing UE 102 with a merchant reader (e.g., tapping, contacting, or placing UE 102 proximate to a reader) or conducting an online transaction via a website, application, or mobile application. Wallet system 104 may access storage 116 and send actual payment card information or tokenized payment card information for payment of the good(s) and/or service(s). Wallet system 104 may also access storage 116 for retrieving consumer preferences and encoding the consumer preference data into offer requests sent to POIP 110. Consumer preferences (e.g., what offers to retrieve, the types of offers to receive, or the like) may be stored in storage 116 for use in generating an offer request.

Storage 116 may be disposed at UE 102, EDS 114, and/or a server associated with wallet system 104. In some embodiments, wallet system 104 includes a mobile application, platform, or service owned and operated by MasterCard® International Incorporated of Purchase, N.Y., USA. Wallet system 104 may include a service offered via MasterCard®, such as MasterCard® Digital Enablement Service (MDES™) or MasterPass™. Wallet system 104 may include any service and/or infrastructure that is owned, operated, and/or otherwise supported by technologies including ApplePay®, Samsung Pay®, Android Pay®, PayPal®, or the like.

In some embodiments, wallet system 104 includes a payment service or system in which consumers, issuer(s) 106, and/or merchant(s) 108 may enroll or subscribe for facilitating various aspects of a purchase transaction. Wallet system 104 may be used to communicate payment information between various network entities for authorizing and clearing the purchase transaction so that funds can be delivered to merchants 108 as payment for the good(s) and/or service(s) purchased by a consumer using UE 102. For illustration purposes only, wallet system 104 is shown as an entity that is remote from UE 102, which may be accessed via signaling across network N. For example, wallet system 104 may include payment software hosted by a remote computing platform or server. However, in other embodiments, wallet system 104 is a digital wallet system that is downloaded or otherwise configured on UE 102 for facilitating in-store purchases via UE 102.

Still referring to FIG. 1 and in some embodiments, POIP 110 includes functionality for receiving offer requests that match metadata corresponding to transaction details (e.g., associated with a purchased good or service), metadata corresponding to location details, and/or metadata corresponding to consumer preferences. The metadata includes data or data elements that are assigned to any of the transaction details, location details, and/or consumer preferences via wallet system 104, EDS 114, and/or UE 102 individually or in any combination. That is, wallet system 104 may receive transaction and location data from a merchant POS, translate the transaction and location data into metadata or data elements, and send the metadata to POIP 110. Wallet system 104, EDS 114, and/or UE 102 may also retrieve consumer preferences from storage 116 and translate the consumer preferences into metadata or data elements.

One transaction detail may be associated with, correlated to, and/or translated into multiple metadata entries (or different metadata) for increasing the quality and relevance of offers sent to the consumer. For example, where a SKU-level transaction detail indicates that a consumer purchased BRAND X dog food, the metadata that may be ascribed, assigned, or otherwise translated as a result of receiving this transaction detail as input at wallet system 104 may include “pet”, “dog”, and/or “pet food”. In some embodiments, metadata identifies “categories” or “labels” that are assigned at wallet system 104 and communicated to POIP 110 via a name, code, or other identifier.

Transaction details (e.g., SKU-level data, or the like) may be translated into metadata so that offers for complementary products available from any number of merchants may be retrieved, integrated, and presented to the consumer. Similarly, location details (e.g., longitude/latitude, GPS data, location data, or the like) can be translated into metadata so that offers in close proximity to a consumer and/or merchant may be retrieved, integrated, and presented to the consumer.

Metadata corresponding to transaction details, location details, and/or consumer preferences may be communicated individually or simultaneously. All three types of information (e.g., transaction, location, preference information) can be, but do not have to be communicated in each offer request. For example, transaction details may be optional, location details may be optional, or consumer preferences may be optional. Some offer requests may be devoid of location details, but include metadata corresponding to transaction details and consumer preferences. Offer requests may include metadata corresponding to transaction details, location details, consumer preferences either alone, or in any combination.

In some embodiments, multiple (e.g., two, three, four, etc.) metadata entries may be assigned to one SKU-level detail or location detail. The metadata may be assigned (e.g., translated, matched, tagged, flagged, etc.) to transaction details and location details via wallet system 104 according to an encoding system that may be provisioned and/or optionally stored in storage 116 and used to translate individual transaction details into metadata, also referred to as “data elements”. The metadata is translated from various SKU-data specific to line item goods purchased by a consumer, and may be assigned according to any hierarchy and/or categorical system implemented by wallet system 104, and may include input from merchants 108, issuers 106, and/or consumers (customers).

Table 1 below includes exemplary embodiments of transaction details disposed in storage 116, in which transaction details such as SKU-level information identifying a specific good is tagged, flagged, or otherwise translated into a label, code, or category using metadata. Transaction details are translated into metadata at wallet system 104, and the metadata is sent via a packet-based network to POIP 110 for use in querying multiple engines 112. Similarly, any data provided via EDS 114 may be combined to generate metadata at the EDS 114, and the metadata can then be sent via a packet-based network to POIP 110 for use in querying multiple engines 112. In some embodiments, multiple tables may be stored and/or otherwise accessed for use in generating and sending an offer request to POIP 110 for retrieving relevant offers from engines 112.

TABLE 1

| Transaction Details | Metadata |
|---|---|
| (e.g., SKU Information) | (Data Elements) |
| BRAND A MILK | Milk, Dairy, Beverage |
| BRAND B PEANUT BUTTER | Lunch, Tree Nut, Food |
| BRAND C VIDEO GAME | Gaming, Entertainment |
| BRAND D TELEVISION | Home Entertainment, Television, |
| | Electronics |
| BRAND E DOG TREATS | Pet, Dog |
| BRAND F WOMEN SHOES | Women, Fashion, Clothing, Foot |
| BRAND G DIAPERS | Baby, Baby Health, Diapering |
| BRAND H SHAMPOO | Personal Health Item, Soap, Cleaning |

As Table 1 illustrates above, SKU-information relating to specific items purchased are flagged with metadata and sent in an offer request to POIP 110. Table 1 is for exemplary purposes only, as other transaction details that may be communicated to POIP and optionally flagged with metadata include a consumer's physical location at the time of the transaction, the time of the transaction, and any other detail reported by the merchant.

Location details and consumer preferences may also be translated to metadata for use in retrieving and presenting offers in the same vicinity as the consumer, and time of day metadata may be used in retrieving and presenting offers that are typically redeemed at peak times (e.g., offers for pizza between 5 PM and 9 PM, or the like). The transaction details, location details, the consumer's preferences, and/or metadata relating to such details may be optionally stored in storage 116 for use in generating and accumulating thereby providing a historical record or accounting of a consumer's purchases, which may be leveraged for providing targeted offers from different merchants that have an increased relevance as the targeted offers are based on a consumer's shopping habits and/or behaviors over time.

Still referring to FIG. 1 and in some aspects, POIP 110 receives an offer request with or without the metadata from UE 102, EDS 114 and/or wallet system 104, and determines a set of criteria from the metadata or the basic request details themselves. POIP 110 may communicate with other network entities (e.g., wallet system 104, engines 112, etc.) via a network interface such as, for example, invoking an application programming interface (API) configured to assist otherwise distinct applications in communicating via a series of API calls, request, and/or answers. The criteria may be based on the SKU-level information alone or combined with any other transaction detail(s), location detail(s), (e.g., a consumer's physical location, zip code, GPS information), and/or consumer-specified interests.

Notably, transaction and location details are used to discern a consumer's transactional behavior across a wide variety of merchants so that specific targeted offers are generated via predictive analysis using a set of criteria that may be retrieved from multiple engines 112 and sent to a consumer. POIP 110 includes functionality for querying engines 112 using a set of criteria for retrieving offers that correlate to an offer request. A plurality of engines 112 are configured to send POIP 110 any relevant offers and/or rewards in response to receiving a query or a request from POIP 110. POIP 110 is configured to integrate the plurality of offers and/or rewards and respond to the offer request with an offer response that includes any relevant offers. A single offer response may include multiple, integrated offers. Notably, the plurality of engines 112 may be privately hosted and/or public offer engines hosted by any public or private entity, corporation, brand-owner, advertising entity, marketing entity, public relations entity, agent, or the like.

Still referring to FIG. 1, POIP 110 includes a processor 120, memory 122, an offer correlating & integrating engine (OCIE) 124, and storage 126. FIG. 1 illustrates POIP 110 as a block diagram of an exemplary system for electronically integrating and correlating offers based on transaction details, location details, and/or consumer preferences according to an embodiment of the subject matter described herein. Although not shown in this embodiment, POIP 110 may also include at least one interface executing software for exchanging information (e.g., via an API-API exchange) between one or more wallet systems 104, EDS 114, UE 102, and/or engines 112.

POIP 110 and the other entities may signal or exchange messages having payloads including transaction details, location details, metadata, consumer preferences, and/or offer details for correlating and integrating multiple offers that are specific to a given consumer. In some embodiments, packets or message traffic (e.g., API-API exchanges) are sent, received and/or otherwise communicated across network N between various entitles.

Processor 120 may include a microprocessor, such as a central processing unit (CPU), or any other hardware-based processor unit that is configured to execute and/or utilize software to communicate with multiple separately hosted engines 112, merchants 108, issuers 106, UEs 102, wallet services 104, and/or EDSs 114, so that consumer specific offers and/or rewards may be collected, correlated, integrated, published, and distributed to the consumer via any of the aforementioned messaging communications and/or at a POS (e.g., an in-store or e-commerce POS). POIP 110 may also publish data streams, data and/or analytics to a plurality of big data customers including merchants 108 and/or issuers 106 for use in intelligent offer generation.

In some embodiments, OCIE 124 is executed by processor 120 and stored in memory 122. OCIE 124 may include hardware, software and/or firmware components configured to utilize API-API exchange technology to receive metadata from UE 102, wallet system 104, and/EDS 114, determine a set of criteria using the metadata as input, and retrieve correlated offers via querying engines 112 with the set of criteria for retrieval of specific offers. In one exemplary implementation, OCIE 124 includes functionality for receiving metadata that corresponds to transaction details (e.g., SKU-data) associated with a purchased good or service, determining a set of criteria from the metadata, querying a plurality of offer or reward engines using the set of criteria for retrieving offers that correlate to the offer request, receiving, via the packet-based network, a plurality of offers from the plurality of offer or reward engines, and integrating the plurality of offers and/or rewards. OCIE 124 includes functionality for receiving metadata that corresponds to transaction details, location details, consumer preferences, and/or any combination thereof.

OCIE 124 is configured to store the retrieved offers (e.g., offer details, offer codes, or offer data), rewards, metadata, criteria, and/or user preferences in storage 126. Storage 126 may include one or more databases, files, tables, data tables, a cache, a storage drive, or any other collection of records or the like for storing information that may be used in correlating and integrating offers for generating a response to an offer request.

In some embodiments, POIP 110 and/or OCIE 124 include functionality for reading, parsing, and/or otherwise processing APIs to exchange information with other entities. OCIE 124 includes functionality for correlating and integrating multiple offers received from engines 112 via processing multiple APIs. Notably, OCIE 124 is configured to leverage APIs from third party, private or public servers (e.g., wallet systems 104, EDSs 114, and/or engines 112) to obtain metadata corresponding to specific line items purchased by a consumer, (e.g., SKU-level metadata), obtain information regarding a consumer location (e.g., geo/GPS metadata), obtain information regarding a consumer's preferences, and obtain offer details from engines 112.

In some embodiments, offer details received from engines 112 may include any details, data, or information regarding an actual offer. Offer details may include any type of details that are related to an offer, including rebate information, a merchant code or identifier, a consumer (customer) identifier, an offer code, an offer amount, an expiration date associated with the offer, a discount amount or percent, redeemable loyalty points, qualifying information (e.g., a consumer must buy 2 boxes of cereal to receive a discount) location information, or the like. Offer information retrieved from engines 112 is integrated at OCIE 124 and sent to wallet system 104, EDS 114, and/or UE 102 for presentation to the consumer, in real time, at a POS.

In some embodiments, memory 122 (e.g., a memory element or device) of POIP 110 includes a random access memory (RAM), a read only memory (ROM), an optical read/write memory, a cache memory, a magnetic read/write memory, a flash memory, or any other non-transitory storage media. In one embodiment, processor 120 and memory 122 may be used to execute and manage the operation of POIP 110. In some embodiments, memory 122 includes any medium that is configured to store (e.g., locally or remotely) consumer preference data, consumer purchasing history, big data, and/or offer data used in correlating and integrating relevant, consumer-specific offers.

Although FIG. 1 depicts POIP 110 as a single node or network element, POIP 110 may further include a plurality of nodes, a plurality of network elements, a plurality of network components, etc., without departing from the scope of the instant subject matter. In some embodiments, POIP 110 provides electronic offer integration and correlation, which may be incorporated with any suitable component or multiple hardware components. POIP 110 may include multiple processors, memory elements, interfaces, or the like.

Notably, POIP 110 is a special purpose computing system or machine that includes hardware components (e.g., one or more processor units, memory, storage, network interfaces, etc.) configured to execute hardware and software elements (e.g., APIs, packets, engines, etc.) for the purposes of performing one or more aspects of the disclosed subject matter herein. In addition, it should be noted that POIP 110 and its components and/or functionality described herein constitute a special purpose computer, system, or platform that improves the technological field pertaining to electronic retrieval and distribution of targeted offers and/or rewards by providing intelligent mechanisms for retrieving and dispersing multiple offers and/or rewards from multiple different merchants or entities that are specifically correlated to a single consumer purchase, consumer preferences, various GEO location elements, and/or consumer spending/purchasing behavior.

Notably, POIP 110 can instruct wallet system 104, UE 102 and/or EDS 114 to send consumers real time alerts regarding consumer-specific offers and/or rewards, including those relevant to the consumer's preferences, location in real time, purchase location, and/or line items (SKU-level) purchased.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., POIP 110, wallet system 104, EDS 114, UE 102, or functionalities thereof may be integrated with any other entities associated with architecture 100.

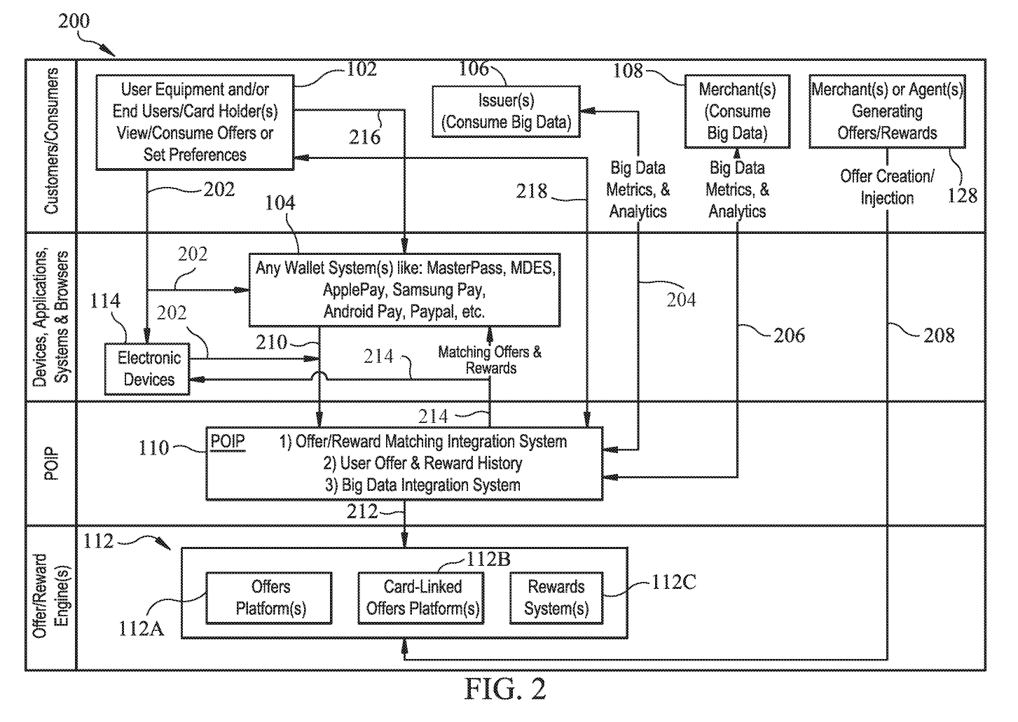

FIG. 2 is a schematic block diagram illustrating entities and exemplary messaging between entities that is associated with a high-level process flow, generally designated 200, which is associated with integrating and correlating offers based on transaction details according to an embodiment of the subject matter described herein. Communications described with respect to FIG. 2 may include packets having payloads with transaction details, location details, or consumer preferences, metadata corresponding to the transaction details, the location details, or the consumer preferences that are correlated or translated into metadata (e.g., transaction specific metadata, location specific metadata, or consumer preference metadata). Communications described with respect to FIG. 2 may also include packets exchanged via an API exchange or call. Communications described in respect to FIG. 2 are for exemplary purposes only, as the communications may occur in a different order than that shown or described, and some communications may occur simultaneously, or nearly simultaneously.

Referring to FIG. 2, a consumer, utilizing UE 102 or EDS 114, may enroll in a service offered by a wallet system 104 (e.g., MasterPass™′ MDES™, ApplePay®, SamsungPay®, AndroidPay®, PayPal®, or the like), which may be accessed via a website, a mobile application and/or any user interface programmed to do so. A consumer may utilize UE 102 or EDS 114 to enroll in a wallet system 104 at a payment platform, to set consumer, offer, reward, or location-based preferences or the like, as indicated by the series of messages denoted by lines 202. Consumer and/or offer preferences may include information, details, or settings regarding the consumer and/or what offers the consumer receives (e.g., brand-specific offers), item/category specific offers (e.g., offers for food, clothing), locations of offers, when the offers are to be received (e.g., at each POS, after e-commerce POS, scheduled, etc.), how the offers are to be received (e.g., texts, alerts, emails, etc.), who sends the offers (e.g., which merchants or systems), or the like. The consumer may set preferences so that before distribution of offers/rewards, the offers or rewards are filtered and/or correlated to the consumer preferences at any individual or combination of the wallet system 104, EDS 114, UE 102 and/or POIP 110.

In line 204, one or more issuers 106 may subscribe to receive data from and/or published by POIP 110 and/or to license data streams communicated to or from POIP 110 for receiving or providing big data, metrics, and/or analytics related to the consumers and/or the offers sent to respective consumers. Such data and analytics may include information used for predictive analysis of consumer spending analytics. For example, issuers 106 may receive data including information regarding the type of purchase made, the items purchased, the purchase location, the purchase method (e.g., in-store or e-commerce), the payment type (e.g., credit card, prepaid card, gift card, etc.), wallet type (e.g. ApplePay®, MasterPass™, etc.), the types of offers being viewed or redeemed, the merchants providing the types of offers redeemed, etc. Data and analytics may include any detail, any bit of information, and/or any bit of data associated with a consumer, merchant, purchase transaction, UE 102, EDS 114, wallet system 104, offer and/or reward involved.

In line 206, one or more merchants 108 may subscribe to POIP 110 and/or license data streams communicated to or from POIP 110 for receiving big data, metrics, and/or analytics related to the consumers and/or the offers sent to respective consumers. Such data and analytics may include information regarding the items purchased at the merchant, the purchase location, the purchase time, the purchase date, the purchase method, the payment type, the types of offers being redeemed, the consumer's preference for offers, etc.

In line 208, merchants or agents 128 create or generate offers and inject the offers into one or more offer engines or reward platforms. For example, merchants 108 or agents 128 may create offers and electronically inject the offers into one or more engines 112, which may comprise one or more offers platform(s) 112A, card-linked offers platform(s) 112B, and/or rewards system(s) 112C. Engines 112 may be platforms including a database, data table, cache, or other storage element containing offer or reward details. Offer or Reward details may include any type of information associated with an offer or reward, including but not limited to rebate information or rebate codes, promo codes, a merchant identifier, a customer (consumer) identifier, an offer code, an expiration date associated with the offer, offer qualifying details, a discount amount or percent, redeemable loyalty points, credits, location information, or the like.

In line 210, wallet system 104 or other EDS 114 may send an offer request to POIP 110 in response to any combination of events, which may be a consumer initiating a purchase transaction via UE 102, a consumer reviewing offers nearby via EDS 114, or a consumer initiating a payment via wallet 104. The offer request may be generated at a POS, when a consumer is conducting a payment transaction for purchasing at least one good or service or when initiating any request providing geographic-based location details. The offer request may include metadata ascribed to transaction details, metadata ascribed to location details, and/or metadata ascribed to consumer preferences, where the metadata is indicative of and/or associated with SKU-details (SKU-data), a location, or other information regarding each item purchased, the time and/or location of the purchase, the day of the purchase, etc. In some embodiments, wallet system 104, UE 102, or EDS 114 may also send consumer preferences (e.g., user preferences) to POIP 110 for optional storage at POIP 110. Alternatively, consumer preferences may be stored in UE 102, wallet system 104, or EDS 114.

In line 212, POIP 110 queries one or more engines 112 using a set of criteria that is determined using the metadata received from wallet system 104, UE 102, or EDS 114. The metadata may be used to create a predictive algorithm and/or be fed into an existing predictive algorithm that identifies criteria used to interrogate engines 112. POIP 110 may use one or more sets of inputs when querying engines 112, for example, POIP 110 may generate criteria based upon a plurality of transaction and/or location metadata for determining matching offers/rewards. POIP 110 may also use, as input, metadata corresponding to a consumer's preferences and/or a consumer's offer and reward history, which has been updated and/or accumulated over time.

In some embodiments, the user offer and reward history may be accessed from storage at wallet service 104, EDS 114, UE 102, and/or from any other storage element assessable by POIP 110. Once offers have been matched to metadata and/or an offer history, POIP 110 may integrate all of the messages and formulate an offer response for responding to the offer request (e.g., line 210) from wallet system 104 and/or EDS 114. In some embodiments, POIP 110 may receive, in the offer request, metadata corresponding to the consumer's purchasing history over a period of time, where the period of time may include a day, a week, a month, a quarter, a year, or longer.

In line 214, after querying engines 112, POIP 110 sends matching offers and/or rewards to wallet system 104 or EDS 114 via an offer response. The offer response may include offer details or data elements, which include information regarding one or more offers (e.g., a merchant code, an expiration date, an offer code, or the like).

In line 216, a consumer views and/or consumes the offers via a wallet system 104 user interface. In line 218, a consumer views and/or consumes the offers or rewards directly from their UE 102, or similarly, a consumer may view and/or consume the offers or rewards via messaging EDS 114 (e.g., as shown in line 202).

It will be appreciated that FIG. 2 is for illustrative purposes only and various messages (communications), message sequencing, and/or message content described above in relation to FIG. 2 may be changed, altered, edited, or removed where necessary. For example, some messages and/or process steps may be separated or combined into more than one or less than one message. Other messages and/or process steps may occur simultaneously, or in a different order than that shown.

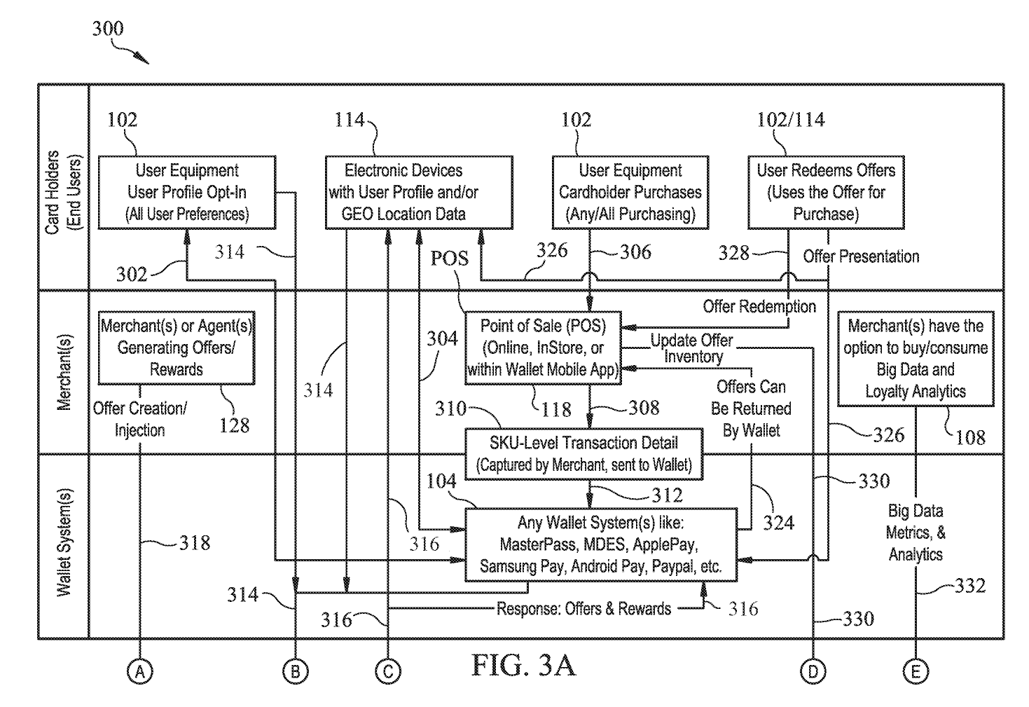

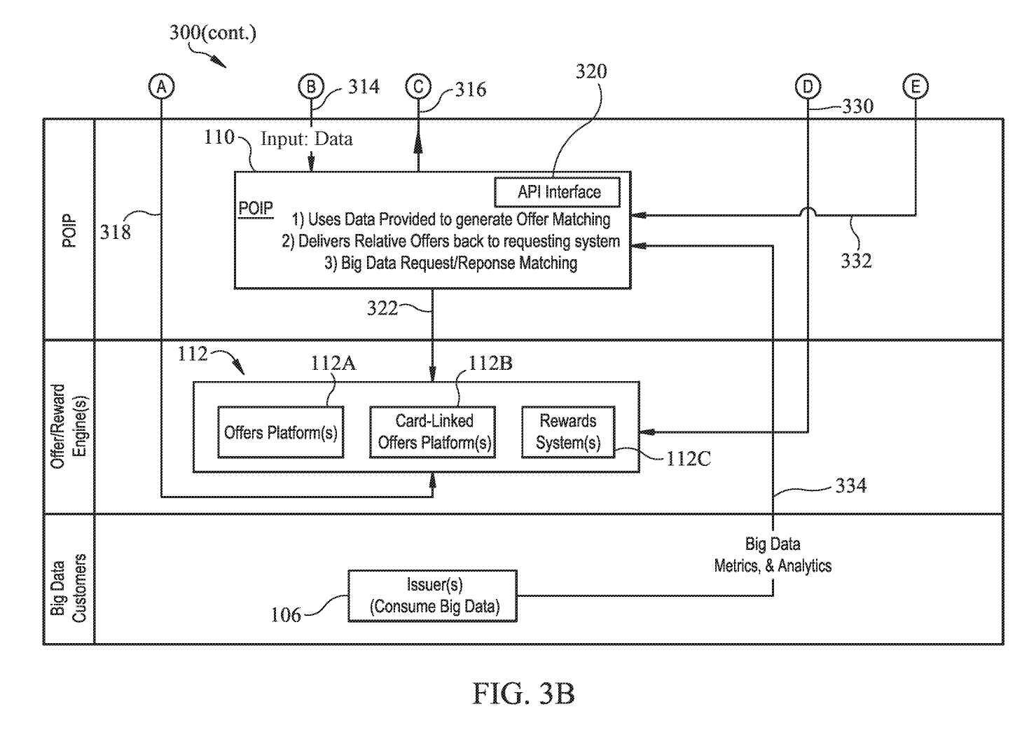

FIGS. 3A and 3B are schematic block diagrams illustrating entities and exemplary messaging between entities for a more granular process flow, generally designated 300, which is associated with integrating and correlating offers based on transaction details according to an embodiment of the subject matter described herein. Process flow 300 is more granular than that shown in FIG. 2, which is powered via the exchange of granulate packet data specific to offers valued by a consumer. This provides a better understanding of consumer behavior and interests as driven by the unique user and unique item(s) or service(s) being purchased.

Referring to FIG. 3A and in some embodiments, a consumer initially signs-up, enrolls, or otherwise, “opts-in” to receive services provided. For example and in one embodiment, at line 302 a consumer may utilize UE 102 to sign-up, enroll, or otherwise “opt-in” to receive payment and offer services provided via wallet system 104. In another embodiment, at line 304 a consumer, for example, may utilize an electronic device such as EDS 114 to sign-up, enroll, or otherwise “opt-in” to receive offer services provided. The consumer may create a user profile including a user name (identifier) and/or a password, and set preferences regarding offer retrieval and presentation. The consumer may input payment card information, which may optionally be stored as tokenized payment information at wallet system 104. The consumer may also set user preferences that identify, for example, offer categories they wish to receive notifications about (e.g., clothing, food, pet products, baby products, etc.), their interests, the times they wish to receive offers, or the like.

Similarly, the consumer (e.g., via UE 102 and/or EDS 114), may request offers or share GEO location details, as indicated by lines 314, which may optionally be stored within any combination of UE 102, wallet system 104, and/or EDS 114. The consumer may also set user preferences that identify, for example, offer categories they wish to receive notifications about (e.g., clothing, food, pet products, baby products, etc.), their interests, the times they wish to receive offers, specific locations they are seeking offers, the manner in which they receive those offers (e.g. email, phone, SMS message, text message, MMS message, electronic mail, etc.) or the like. The consumer may set user preferences via UE 102 and/or EDS 114.

The consumer may also utilize UE 102 and/or EDS 114 to opt-in to location services and/or set location preferences. Location preferences may specify whether offers are sent based upon the consumer's location. The consumer may need to specify and/or “opt-in” to location preferences to allow wallet system 104 and/or EDS 114 to access and share a consumer's location with POIP 110 for use in querying engines 112. Wallet system 104 or EDS 114 may send POIP 110 the consumer location or metadata corresponding to the consumer's location and/or the location where a purchase or request was made.

The consumer may then utilize UE 102 and/or EDS 114 to make a purchase. For example, in line 306, a consumer utilizes UE 102 to make a purchase for a good or service at a merchant POS. The POS may be an in-store merchant POS or an e-commerce POS occurring at a merchant website or via a mobile application.

The payment transaction occurring at the merchant POS triggers the merchant to send transaction details at line 308, the transaction details may include location details and/or any other digital receipt details including SKU-level transaction details to wallet system 104. At block 310, transaction details are captured at a merchant POS (e.g., a merchant server, a merchant's payment authorization server, or the like) and sent to wallet system 104.

At line 312, the transaction details, including the SKU-level transaction details captured by the merchant, are communicated to wallet system 104 via a packet-based network. Wallet system 104 is configured to flag, tag, translate, assign, or otherwise associate the transaction details with metadata, and store the association between the transaction details and the metadata in storage (e.g., 116, FIG. 1). Location details and/or consumer preferences may also be translated into metadata at wallet system 104 and stored therein.

At lines 314 spanning FIGS. 3A and 3B, at least one of wallet system 104, EDS 114, and/or UE 102 sends an offer request including any assigned metadata to POIP 110. Notably, wallet system 104 may automatically send an offer request on behalf of the consumer at the time of purchase simply by conducting a purchase transaction. No loyalty card or other qualifying identifier must be presented in order to receive the offers, as the consumer “opts-in” to receive offers. Similarly, UE 102 or EDS 114 may automatically send an offer request (such as via the messaging shown at lines 314) on behalf of the consumer based on any related user preferences such as location (GEO location/GPS), time of day and/or proximity to various merchants. The metadata may be associated with the transaction details, location details, and/or consumer preferences translated by the EDS 114, UE 102, and/or wallet system 104 and communicated to POIP 110. In some embodiments as FIGS. 3A and 3B illustrate, SKU data (metadata translated from SKU-data) may be sent to POIP 110 via an offer request communicated at line 314.

Referring now to FIG. 3B, POIP 110 receives the offer request sent at line 314, and uses the data to generate a set of criteria used to interrogate or query engines 112 and generate an offer matching algorithm. Notably, POIP 110 is configured to receive transaction details, which may include SKU-level details (information, alphanumeric codes, alphanumeric identifiers unique to a specific merchant good, etc.), of the items purchased from a merchant, which were passed from the merchant's payments system to wallet system 104 at time of checkout. Upon receipt of an offer request, POIP 110 is triggered to retrieve all similar or related items offered by the same or other merchants 108 or agents 128 or financial institutions such as issuers 106, banks, etc. This is accomplished by correlating the specific SKUs, which may have been purchased in conjunction with other similar offers in the general vicinity of the consumer based on the transaction location (e.g., location details regarding a merchant longitude and latitude) or other location information (ISP or Mobile application GPS location) and deliver more specific offers to the consumer at the POS, post-checkout live on the merchant's site or the merchant's location via email (if the consumer is subscribed), and/or via a wallet system 104 application user interface.

Referring now to FIG. 3B, POIP 110 receives the offer request sent at line 314, and uses the data to generate a set of criteria used to interrogate or query engines 112 and generate an offer matching algorithm. Notably, POIP 110 is configured to receive numerous combinations of user details, preferences, GEO location, etc., from EDS 114 and/or UE 102. Upon receipt of an offer request, POIP 110 is triggered to retrieve all relevant offers and deliver those in real time, in response to a request from UE 102, wallet system 104, and/or EDS 114 as illustrated at line 316.

Before responding and as illustrated at lines 322, POIP 110 may query one or more respective engines 112, which may comprise one or more systems such as one or more offer platforms 112A, card-linked offers platforms 112B, and/or rewards systems 112C, using the set of criteria determined in view of transaction-specific metadata, location-specific metadata, consumer preference metadata, and/or any combination thereof. For example and in some embodiments, POIP 110 queries each engine 112 using a set of criteria developed via inputting metadata derived from transaction details.

At line 316 spanning FIGS. 3A and 3B, POIP 110 sends an offer or reward response answering the offer request sent at line 314. The offer or reward response includes multiple offers and rewards, or details corresponding thereto, which were retrieved, correlated, and integrated at POIP 110. Notably, the multiple offers and rewards may include offers retrieved from different privately hosted and/or publicly hosted servers, platforms, or offer engines. The offers and rewards may include offers created by different merchants, advertisers, corporate brands, or the like that are integrated into a single offer response at line 316

As line 318 (communications terminating at A-A spanning FIGS. 3A and 3B) illustrates, multiple merchants and/or agents 128 may create, generate, and inject offers and rewards into the multiple offer engines 112. This may occur at any time and in any order, other than that shown.

An API interface 320 (FIG. 3B) is configured at POIP 110 for facilitating API-API exchanges or calls between different entities having distinct applications that are configured to share transaction data, location data, metadata, offer information, and/or consumer preference information associated with a POS transaction across a packet-based network. Interface 320 may be used to communicate or exchange offer requests and responses between wallet system 104 and POIP 110. Interface 320 may also be used to communicate or exchange offer information between engines 112 and POIP 110 and/or big data and analytics to issuers 106 and/or merchants 108. Interface 320 may also be used to communicate or exchange offer information between UE 102 and/or EDS 114 and POIP 110.

At line 324 in FIG. 3A, wallet system 104 may receive multiple offers from POIP 110, and communicate the offers in real time, to a consumer via UE 102 or EDS 114 at the merchant POS. Line 324 is indicative of the point in time during a purchase transaction at which the offer(s) can be communicated to the consumer. The offers may include offers relating to purchased line-items, offers in a same geographic area/location as the POS, or offers POIP 110 predicts a consumer will have interest in based upon the consumer's purchasing history and preferences.

At line 326, wallet system 104 presents the offers to a consumer via UE 102 or EDS 114. The offers may be presented to the consumer via a user interface (e.g., a display, a screen, etc.) according to any preferred method, including a text message, a Short Message Service (SMS) message, a Multimedia Messaging Service (MMS) message, an email message, an alert, a notification, a code, an alarm, an audible sound, a vibratory sensation, or the like.

At line 328, the consumer may redeem an offer via instructing UE 102 or EDS 114 POS, which may be a different or same POS used to initiate the purchase, and POS may include either a physical or virtual (web/browser-based) POS.

At line 330, which spans FIGS. 3A and 3B, the offer inventory may be updated at a respective engine 112 directly. Updating the offer inventory includes entering a code or other indicator that signals to the engine 112 directly that an offer has been redeemed.

At line 332, which spans FIGS. 3A and 3B, merchants 108 have the option to subscribe to POIP 110 for consuming, licensing, and/or buying big data and loyalty analytics.

At line 334 in FIG. 3B, issuers 106 have the option to subscribe to POIP 110 for consuming, licensing, and/or buying big data and loyalty analytics.

It will be appreciated that FIGS. 3A and 3B are for illustrative purposes only and various messages (communications), message sequencing, and/or message content described above in relation to FIGS. 3A and 3B may be changed, altered, edited, or removed where necessary. For example, some messages and/or process steps may be separated or combined into more than one or less than one message. Other messages and/or process steps may occur simultaneously, or in a different order than that shown.

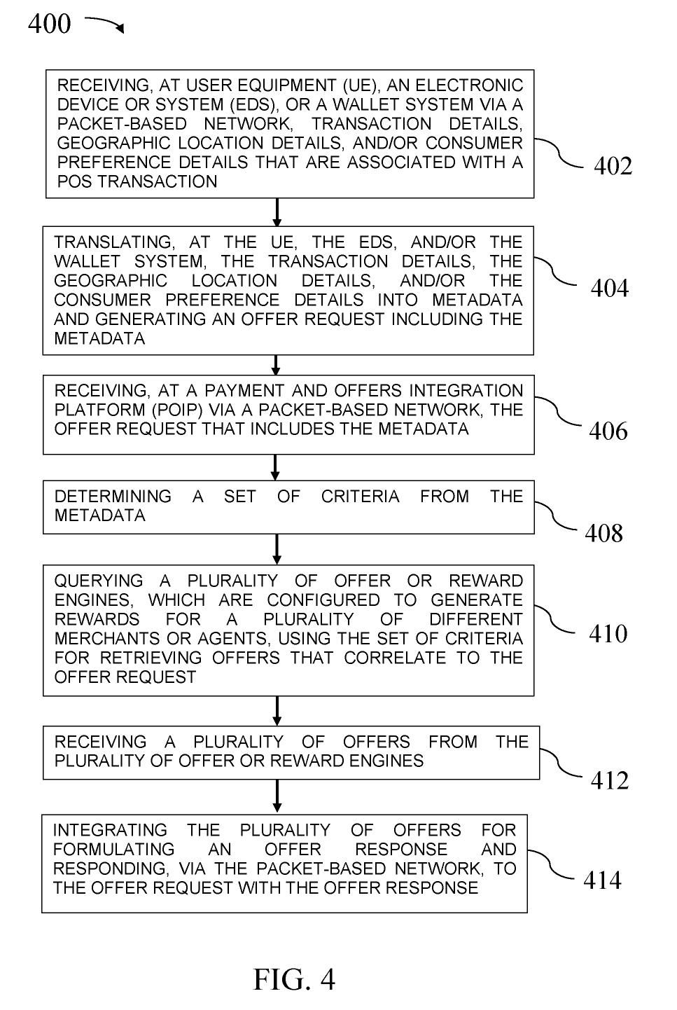

FIG. 4 is a schematic block diagram illustrating an exemplary process 400 for integrating and correlating offers based on transaction details. The process may occur at a wallet system (e.g., 104, FIG. 1), UE (e.g., 102, FIG. 1), electronic device (e.g., 114, FIG. 1) and a POIP (e.g., 110, FIG. 1), each of which may include at least one processor and memory having stored thereon executable instructions that when executed by the processor, control the computer to perform the process 400.

In block 402, user equipment (e.g., 102, FIG. 1), an electronic device (e.g., 114, FIG. 1) and/or a wallet system (e.g., 104, FIG. 1) receive or provide transaction details, geographic location details, and/or consumer preference details. Such details may be flagged, tagged, correlated, matched, encoded, translated into, assigned, and/or otherwise associated with metadata, such as data corresponding to one or more categories indicative of a specific item purchased (e.g., food, dairy, diapers, etc.), a specific merchant (e.g., a merchant code) or the like. Location details may be flagged, tagged, or otherwise translated into metadata based upon information regarding the consumer or merchant location (e.g., GPS coordinates or the like). Consumer preference details may be stored or accessed by a wallet system (e.g., 104, FIG. 1) and translated into metadata for determining offers. The transaction and/or location details may be in the form of a digital receipt, which may then be flagged with metadata at a wallet system at a POS.

In block 404, user equipment (e.g., 102, FIG. 1), an electronic device (e.g., 114, FIG. 1) and/or the wallet system (e.g., 104, FIG. 1) translate the transaction details, the geographic location details, and/or the consumer preference details into metadata which may be associated with a POS transaction, and generates an offer request including the metadata.

In block 406, a POIP may receive the offer request that includes the metadata via a packet-based network.

In block 408, the POIP may determine a set of criteria from the metadata.

In block 410, the POIP may query a plurality of offer or reward engines, which are configured to generate rewards for a plurality of different merchants or agents, using the set of criteria for retrieving offers that correlate to the offer request.

In block 412, the POIP may receive and/or retrieve a plurality of offers from the plurality of offer or reward engines via the packet-based network.

In block 414, the POIP may integrate the plurality of offers for formulating an offer response and respond to the offer request with the offer response via the packet-based network.

As indicated above, the POIP (e.g., 110, FIG. 1), wallet system (e.g., 104, FIG. 1) and/or the functionality ascribed to either entity as described herein constitute special purpose computers. Further, it will be appreciated that the POIP (e.g., 110, FIG. 1), wallet system (e.g., 104, FIG. 1) and/or the functionality ascribed can improve the technological field pertaining to packet communications for correlating and integrating multiple offers retrieved from multiple different merchants or agents, where the multiple offers are relevant to a consumer (e.g., by virtue of being correlated to transaction specific details), and presented to a consumer at a POS, through user equipment (e.g., 102) or through electronic devices or systems (e.g., 114).

Correlating and integrating offers using transaction details, location details, and/or customer preference details advantageously obviates the need for manually processing offers, manually searching offers, and generating irrelevant offers. Multiple parties may subscribe to data and/or data streams associated with correlated, integrated, presented and/or redeemed offers for benefiting from big data and analytics. Notably, correlating and integrating offers via POIP (e.g., 110, FIG. 1) is necessarily rooted in computer technology in order to overcome a problem specifically arising in the realm of computer networks (i.e., retrieving, integrating, and presenting multiple offers from merchants using electronic or digital transaction details via a POIP computing platform).

Systems, methods, and computer readable media for electronically integrating and correlating offers based on transaction/location/customer preference details may provide, for example and without limitation, one or more of the following beneficial technical effects: enabling multiple parties to subscribe to integrated data; allowing consumers to input consumer-specific preferences; presenting specific targeted offers via predictive analysis on data associated with transaction specific details indicative of consumer behavior and/or location; more intelligent offer generation, retrieval, integration and presentation; leveraging line-item goods and service purchasing history for providing improved electronic offers; providing data streams for licensing; providing offers targeting consumer-specific interests and consumer-specific location for enriching payment industries; real time integration and presentation of multiple offers from multiple different agents or merchants at a POS; improving mobile payments platform via offer integration; more robust offer engines; significant savings on purchases for consumers; monetization of consumer shopping behavior and offer redemption analytics; improved marketing to key consumer demographics; SKU purchase habits; and/or making more informed business decisions based on consumer engagement.

While the subject matter has been has been described herein in reference to specific aspects, embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method for integrating and correlating offers based on transaction details, geographic locations, and/or consumer preferences, the method comprising:
receiving, at a wallet system, transaction details, geographic location details, and/or consumer preference details that are associated with a point of sale (POS) transaction;
translating, at the wallet system, the transaction details, the geographic location details, and/or the consumer preference details into metadata associated with the POS transaction and generating an offer request including the metadata;
receiving, at a payment and offers integration platform (POIP), the offer request that includes the metadata;
determining, at the POIP, a set of criteria from the metadata;
querying a plurality of offer or reward engines, which are configured to generate rewards for a plurality of different merchants or agents, using the set of criteria for retrieving offers that correlate to the offer request;
receiving, at the POIP, a plurality of offers from the plurality of offer or reward engines;
integrating, at the POIP, the plurality of offers for formulating an offer response; and
responding to the offer request with the offer response.

2. The method according to claim 1, wherein the offer request is generated at a physical POS, an online POS, at the user equipment and/or via electronic device.

3. The method according to claim 2, wherein the offer response is communicated to a consumer in real time, at the physical POS, at the online POS, at the user equipment and/or via electronic device.

4. The method according to claim 1, further comprising receiving a plurality of transaction details including at least one stock keeping unit (SKU) code or at least one merchant code.

5. The method according to claim 1, further comprising receiving a plurality of transaction details, wherein each of the plurality of transaction details is associated with a plurality of metadata entries.

6. The method according to claim 1, further comprising receiving a plurality of transaction details including stock keeping unit (SKU) data that is translated into metadata.

7. The method according to claim 1, wherein the offer request and the offer response are exchanged via an application programming interface (API) call between the wallet system, user equipment or electronic device and the POIP.

8. The method according to claim 1, wherein the offer request is generated in response to receiving a digital receipt from a merchant server conducting the POS transaction.

9. The method according to claim 1, further comprising receiving, in the offer request, a plurality of metadata entries corresponding to a consumer's purchasing history over a period of time.

10. The method according to claim 1, further comprising receiving, in the offer request, a plurality of metadata entries corresponding to a consumer's preferences.

11. The method according to claim 1, further comprising receiving, in the offer request, at least one metadata entry corresponding to a consumer's location, a merchant's location, or a combination thereof.

12. The method of according to claim 1, wherein the offer request and the offer response are communicated via a packet-based network.

13. A system for integrating and correlating offers based on transaction details, the system comprising:
a wallet system configured to receive transaction details, location details, and/or customer preferences associated with a point of sale (POS) transaction, translate the transaction details, the location details, and/or the customer preferences into metadata associated with the POS transaction, and generate an offer request including the metadata;
a payment and offers integration platform (POIP) configured to receive the offer request that includes the metadata, determine a set of criteria from the metadata and query a plurality of offer or reward engines, which are configured to generate rewards for a plurality of different merchants or agents, using the set of criteria for retrieving offers that correlate to the offer request, the POIP is further configured to receive a plurality of offers from the plurality of offer or reward engines, integrate the plurality of offers for formulating an offer response, and respond to the offer request with the offer response.

14. The system according to claim 13, wherein the offer request is generated at a physical POS or an online POS.

15. The system according to claim 14 wherein the offer response is communicated to a consumer in real time, at the physical POS or the online POS.

16. The system according to claim 13, wherein the wallet system receives a plurality of transaction details that includes at least one stock keeping unit (SKU) code that is associated with at least one purchased good or service or at least one merchant code.

17. The system according to claim 13, wherein the wallet system receives a plurality of transaction details, and each of the plurality of transaction details is associated with a plurality of metadata entries.

18. The system according to claim 13, further comprising an application programming interface (API) between the POIP and the wallet system for exchanging data.

19. The system according to claim 13, wherein the offer request is generated in response to receiving a digital receipt from a merchant server conducting the POS transaction.

20. The system according to claim 13, wherein the metadata corresponds to a consumer's purchasing history over a period of time.

21. The system according to claim 13, wherein the metadata corresponds to a consumer's preferences.

22. The system according to claim 13, wherein the metadata corresponds to a consumer's location, a merchant's location, or a combination thereof.

23. The system of according to claim 13, wherein the offer request and the offer response are communicated via a packet-based network

24. A non-transitory computer readable medium having stored thereon executable instructions that when executed by the processor of a computer control the computer to perform steps comprising:
receiving, at a wallet system, transaction details, geographic location details, and/or consumer preference details that are associated with a point of sale (POS) transaction;
translating, at the wallet system, the transaction details, the geographic location details, and/or the consumer preference details into metadata associated with the POS transaction and generating an offer request including the metadata;
receiving, at a payment and offers integration platform (POIP), the offer request that includes the metadata;
determining, at the POIP, a set of criteria from the metadata;
querying a plurality of offer or reward engines, which are configured to generate rewards for a plurality of different merchants or agents, using the set of criteria for retrieving offers that correlate to the offer request;
receiving, at the POIP, a plurality of offers from the plurality of offer or reward engines;
integrating, at the POIP, the plurality of offers for formulating an offer response; and
responding to the offer request with the offer response.

25. An electronic device or other user equipment which contains computer readable medium having stored thereon executable instructions that when executed by the processor of a computer control the computer to perform steps comprising:
receiving, within a system, geographic location details, and/or consumer provided details that are associated with the consumer's location or preferences;
translating, within the system, the geographic location details, and/or the consumer preference details into metadata associated with the consumer preferences and/or location-based details and generating an offer request including the metadata;
receiving, at a payment and offers integration platform (POIP), the offer request that includes the metadata;
determining, at the POIP, a set of criteria from the metadata;
querying a plurality of offer or reward engines, which are configured to generate rewards for a plurality of different merchants or agents, using the set of criteria for retrieving offers that correlate to the offer request;
receiving, at the POIP, a plurality of offers from the plurality of offer or reward engines;
integrating, at the POIP, the plurality of offers for formulating an offer response; and
responding to the offer request with the offer response.
